(19) United States
(12) Patent Application Publication
(10) Pub. No.: US 2005/0289212 A1
(43) Pub. Date: Dec. 29, 2005

(54) Non-transactional resource reference

(76) Inventors: Nikolal D. Tankov, Sofia (BG); Peter K. Matov, Velingrad (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/858,657

(22) Filed: Jun. 1, 2004

(51) Int. Cl. G06F 15/16

(52) U.S. Cl. 709/200

(57) ABSTRACT

A system and method for a non-transactional resource reference are disclosed. According to an embodiment of the invention, a method comprises establishing a program object, the program object containing information regarding creation of a connection between a computer application and a resource; and establishing a local transaction and associating the computer application with the local transaction, a global transaction being active at the time of association; the local transaction being uninvolved with the global transaction.

### TECHNICAL FIELD

Embodiments of the invention generally relate to the field of client/server systems and, more particularly, to a system and method for a non-transactional resource reference.

### BACKGROUND

Conventional client/server systems may include the use of transactions in program operations. The operations may include both local transactions, in which a local object generally will control the operation, and global transactions, in which a global transaction manager may be needed.

In a server, a resource adapter object may be utilized for operations of an application with an external resource. The resource adapter may be associated with a transaction, with may be either a local transaction or a global transaction.

However, in conventional operations the resource adapter may not be capable of establishing or associating with a local transaction if a global transaction is in place. The application may not support nested transactions, in which a global transaction and one or more local transactions are in place concurrently at least in part. Instead, the application may only support flat transactions, in which a single transaction is in place, and such transaction is either completed or rolled back before another transaction is commenced. In the conventional operation, the resource adapter will be associated with the global transaction, if any, even if the resource adapter could otherwise operate without connection to the global transaction.

### SUMMARY OF THE INVENTION

A system and method for a non-transactional resource reference are described.

Under a first embodiment of the invention, a method comprises establishing a program object, the program object containing information regarding creation of a connection between a computer application and a resource; and establishing a local transaction and associating the computer application with the local transaction, a global transaction being active at the time of association; the local transaction being uninvolved with the global transaction.

Under a second embodiment of the invention, a server system comprises an application server, the application server including an application; and an interface to an external resource, the server system to establish a connection between the application and the external resource; the connection to be associated with a local transaction, the local transaction to be concurrent at least in part with a global transaction.

Under a third embodiment of the invention, a server system comprises means for establishing a connection between an application and an external resource; means for establishing a local transaction; and means for associating the application with the local transaction, a global transaction being active at the time of association, the local transaction and global transaction operating concurrently at least in part.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of a transaction associated with a program thread;

FIG. 2 is an illustration of local and global transactions;

FIG. 3 is an illustration of an embodiment of a server utilizing multiple resource managers to provide connections;

FIG. 4 is an illustration of a server system containing a single resource system for a server connecting multiple containers and multiple resources;

FIG. 5 is an illustration of nested transactions under an embodiment of the invention;

FIG. 6 is a diagram illustrating operations for establishment of a non-transactional resource reference under an embodiment of the invention;

FIG. 7 is a diagram illustrating operation for obtaining a non-transactional resource reference under an embodiment of the invention; and

FIG. 8 illustrates an exemplary computer system environment under an embodiment of the invention.

### DETAILED DESCRIPTION

Embodiments of the invention are generally directed to a system and method for providing a non-transactional resource reference.

Under an embodiment of the invention, a program object carries information for tuning up an underlying resource system for a server system. Under embodiment of the invention, the object acts in a manner to provide that requested connections are not involved in an existing global transaction, if any. Under an embodiment of the invention, nested transactions may be implemented, with a nested transaction including a global transaction and one or more local transactions.

An embodiment of the invention may operate in a Java environment, such described in the Java 2 enterprise edition (J2EE) environment provided under the J2EE specification, J2EE (Java 2 Platform, Enterprise Edition), including version 1.4, Nov. 24, 2003. Under an embodiment of the invention, an application may include an Enterprise JavaBean (EJB) program object, including those described in the Enterprise JavaBeans specification, version 2.1, Nov. 12, 2003. Under an embodiment of the invention, connections for a server include those implemented in conformity with the J2EE Connector Architecture Specification (JCA), including version 1.5, Nov. 24, 2003. Under an embodiment of the invention, directory and naming functionality includes that made pursuant to the Java Naming and Directory Interface (JNDI), including version 1.2, Jul. 14, 1999.

Further, the Java Transaction API (JTA) (version 1.0.1B, Nov. 1, 2002) specifies certain local Java interfaces between a transaction manager and the parties involved in a distributed transaction system, such parties being the application, the resource manager, and the application server. The Java Transaction Service (version 1.0, Dec. 1, 1999) specifies a certain implementation of a transaction manager that supports the JTA at high-level and implements Java mapping of the Object Management Group (OMG) Object Transaction Service (OTS), current version 1.4, September 2003, at low-level.

Under an embodiment of the invention, a server system may provide for communications between multiple containers on a server and connectors to resource services, such as external enterprise information services (EIS). Under an embodiment of the invention, containers may include EJB (enterprise Java bean) and WEB containers. Under an embodiment of the invention, connectors include JDBC (Java Database Connectivity), JMS (Java message service) connectors, and JCA (Java connector architecture) services. The JDBC connector service provides for creation and deployment of JDBC adaptors. The JMS connector service provides for creation and deployment of adaptors to the JMS system. The JCA container service may provide for deploying arbitrary resource adaptors.

A transaction is generally an atomic work unit that modifies data. A transaction consists of one or more statements. After completion, all of the statements are either committed or rolled back. In the simplest case, when a commit method (indicating completion of the transaction) or a rollback method (indicating a failure of the transaction, and thus a reversal, or roll back, of all actions taken by the transaction) is called, the current transaction ends and another transaction may begin.

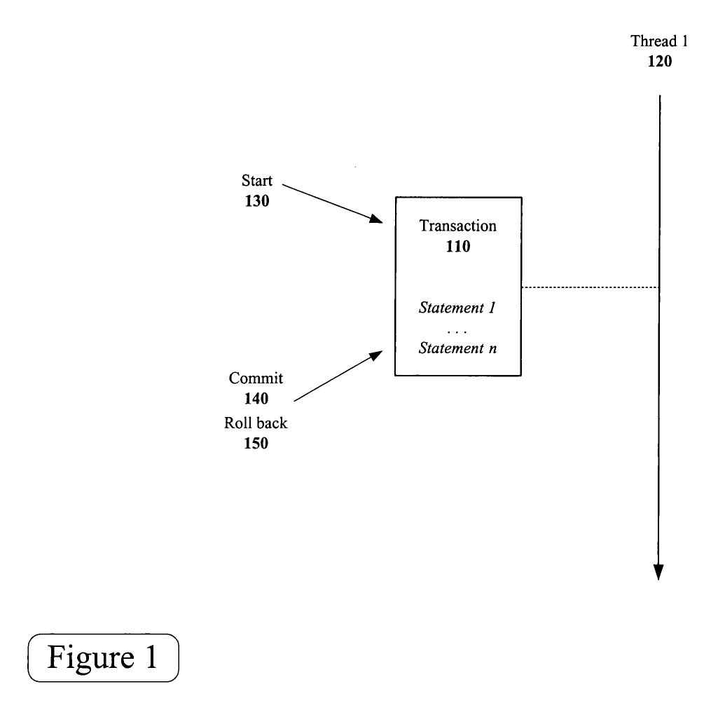

FIG. 1 is an illustration of a transaction associated with a program thread. In this illustration, a transaction 110 is comprised of one or more program statements. The transaction 110 is associated with a particular program thread, shown as thread 1 120. The program thread represents a basic unit of program execution, such as in a Java program environment. The transaction will be started 130 to commence operation. The transaction then will receive either a commit method 140 to complete operations or a roll back method 150 to roll back all actions of the transaction 110 in case of failure.

When a single connection to a database exists, a local program object, such as a resource manager for a connection to an EIS, may directly control the transaction and may be capable of calling commit or rollback methods for the connection. A transaction that operates in this manner is referred to as a local transaction.

In contrast, a global transaction, or distributed transaction, is a set of two or more related transactions that are managed in a coordinated manner. The transactions that constitute a distributed transaction may involve a single database or multiple databases, and may involve multiple locations. Each individual transaction of a distributed transaction is referred to as a transaction branch.

In operations for a global transaction, all database connections are registered with a global transaction service, such as a transaction manager, which controls the transaction. In a global transaction, an EJB will not make calls directly on a database connection. This is in contrast to a local transaction, in which the EJB will make calls directly on the database connection. The local transaction is limited in scope to a single EIS system, and the EIS resource manager may manage the transaction. A global transaction may span multiple resource managers and requires global control. In a global transaction, each resource manager acts to manage resources in conjunction with the transaction manager. A transaction manager is the element responsible for creation of a transaction and its context. To handle global transactions, a transaction manager may utilize a two-phase commit protocol (2PC) to manage a transaction that spans multiple resource managers (with multiple EISs), in which there is first a call to determine whether each resource manager is ready to commit and then a second call to either commit, if all resource managers are ready to commit, or a second call to roll back, if one or more resource managers are not ready to commit. A one-phase commit optimization may be utilized if only one resource manager is participating in a transaction.

Each global transaction is associated with one transaction object when a transaction is created. The transaction object can be used to enlist the transactional resources in use by the application, register for transaction synchronization callbacks, commit or rollback the transaction, and obtain the status of the transaction.

A resource adapter is responsible for opening or initializing a resource manager when the connection to the resource manager is established. The resource manager is then closed by the resource adapter as a result of destroying the transactional resource. The J2EE Connector Architecture defines a transaction management contract between an application server and a resource adapter and its underlying resource manager. The transaction management contract extends the connection management contract and provides support for management of both local and global transactions. The transaction management contract has two parts depending on the type of transaction, either a contract between a transaction manager and an EIS resource manager (in a global transaction) or a local transaction management contract.

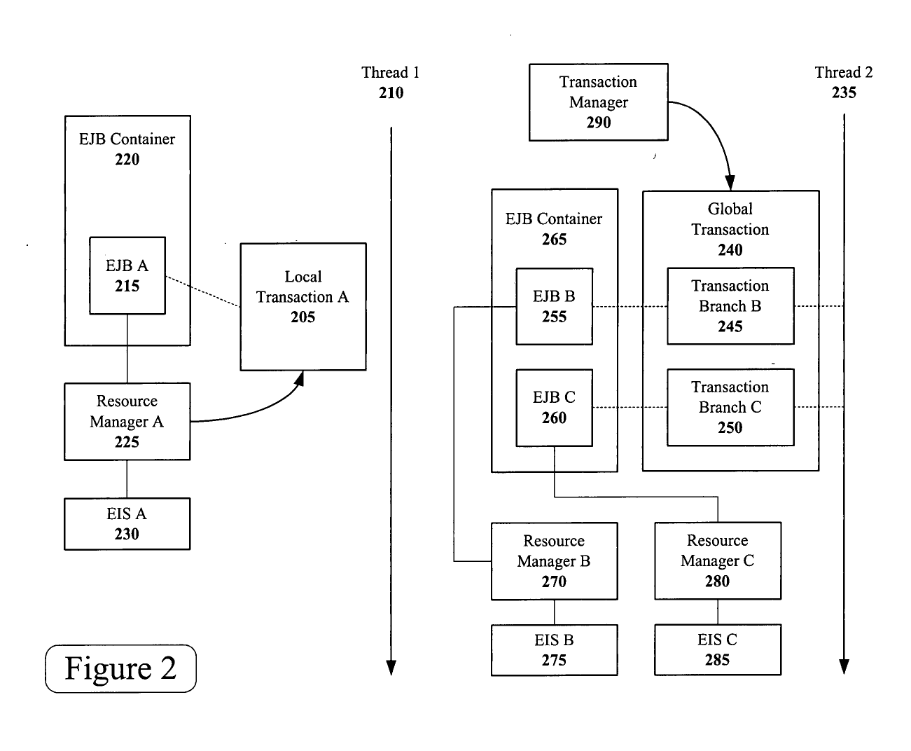

FIG. 2 is an illustration of local and global transactions. In this illustration, a local transaction A 205 is illustrated with a first program thread, thread 1 210. As a local transaction, the transaction A 205 may be subject to local control. In this illustration, transaction A 205 is associated with an enterprise Java bean, shown here as EJB A 215 contained in EJB container 220. A container is entity that provides life cycle management, security, deployment, and runtime services to components, which in this case are EJB program objects. EJB A 215 has a connection with a resource, EIS A 230, utilizing resource manager A 225. As this is a local transaction, the resource manager 225 manages the local transaction 205.

Also illustrated in FIG. 2 is a global transaction 240. The global transaction may be comprised of multiple transactions, shown here as transaction branch B 245 and transaction branch C 250 associated with EJB B 255 and EJB C 260, respectively. As illustrated, components EJB B 255 and EJB C 260 are contained in EJB container 265 and transaction branch B 245 and transaction branch C 250 are both associated with a second program thread, thread 2 235. However, this structure may vary with difference embodiments of the invention. In this illustration, EJB B 245 has a connection with EIS B 275 utilizing resource manager B 270 and EJB C 250 has a connection with EIS C 285 utilizing resource manager C 280. The global transaction 240 is controlled by a global component, shown here as transaction manager 290. The global transaction 240 will be committed or rolled back as a unit. The transaction manager 290 may handle commitment in a two phase process, in which transaction branch B 245 and transaction branch C 250 are first queried to determine whether the transactions are ready to commit and then instructed to either commit, if both transactions are ready to commit, or roll back, if either transaction is not ready to for the commit process.

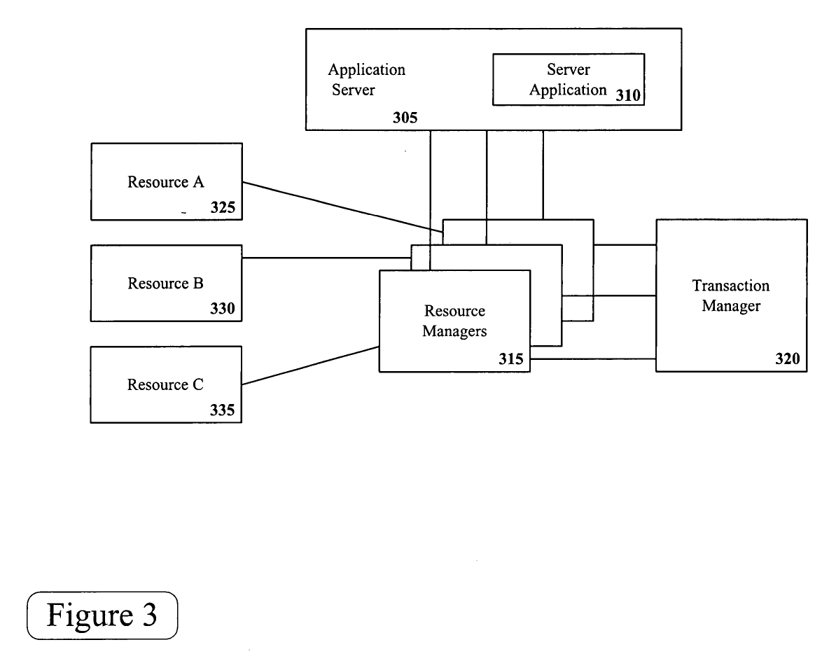

Embodiments of the invention may be utilized in various environments. For example, FIG. 3 is an illustration of an embodiment of a server utilizing multiple resource managers to provide connections. In FIG. 3, an application server 310 includes a server application 310. In this illustration, there are three external resources that the server application 310 may utilize, these resources being illustrated as Resource A 325, Resource B 330, and Resource C 335. In FIG. 3, a resource manager 115 is provided for each connection between the application server 305 and an external resource. The resource manager for each resource is responsible for opening (initializing) the resource adaptor when the connection to the resource manager is established. The resource manager is open until the resource is released. A transaction manager 320 may be responsible for informing each resource manager regarding when to start and end work associated with a transaction and when to complete the transaction. In particular, the transaction manager 320 may be responsible for managing global transactions.

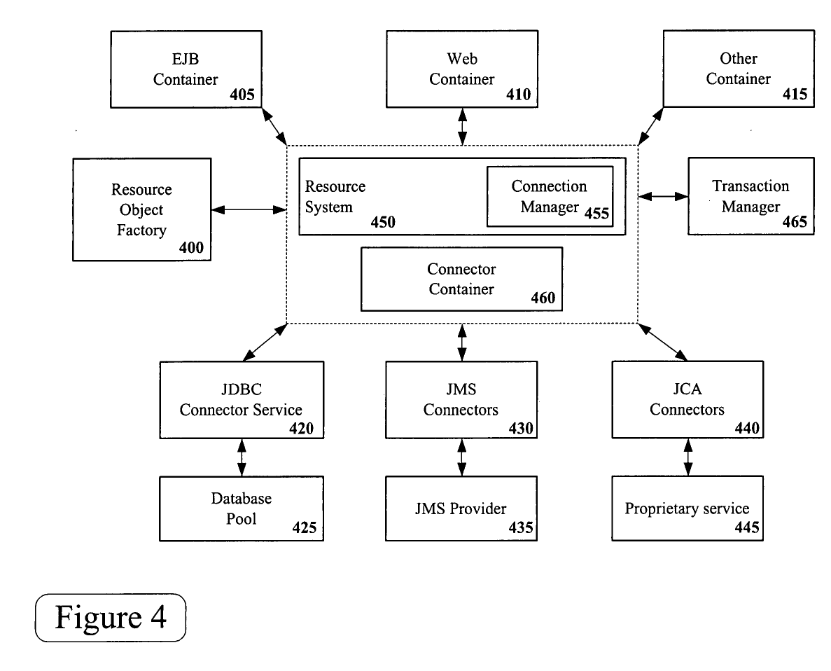

FIG. 4 is an illustration of a server system containing a single resource system for a server connecting multiple containers and multiple resources. In this illustration, there are present an Enterprise JavaBean (EJB) container 405, a web container 410, and another arbitrary container 415. For external resources, there is a database pool 425 that may be connected using a JDBC (Java database connection) connector server 420, a JMS (Java message service provider) 435 that may be connected utilizing JMS connectors 430, and a proprietary service 445 that may be connected using JCA (Java connector architecture) connectors 440. In this illustration, a single resource system 450 is utilized by all applications and external resources. The resource system 450 includes a connection manager 455, and utilizes a connector container 460 to store managed connections. In an embodiment of the invention, the transaction manager 465 is responsible for control of global transactions.

In addition to the concepts of local and global transactions, there is also a question of concurrent operations of separate transactions. A flat transaction comprises a basic transaction, with the flat transaction being either completed or rolled back. In a J2EE environment, the flat transaction may be either a local transaction or a global transaction. In either case, at most either a single local transaction or a single global transaction is in place at any time.

In a nested transaction, operations may be more complex. In general, a nested transaction includes a high level transaction and lower level sub-transactions. In theory, each sub-transaction may comprise one or more flat transactions, one or more sub-transactions, or a combination of each. The transactions in a nested transaction operate concurrently at least in part. For example, an embodiment of the invention may include a nested transaction with a global transaction and one or more local transactions.

A nested transaction may provide advantages in operation. Multiple transactions are possible without association of each connection with a global transaction. By isolating a local transaction, the control of the transaction may then be local. The local transaction thus can be committed or rolled back as a separate entity, and not be required to be part of a roll back or commitment of a global transaction.

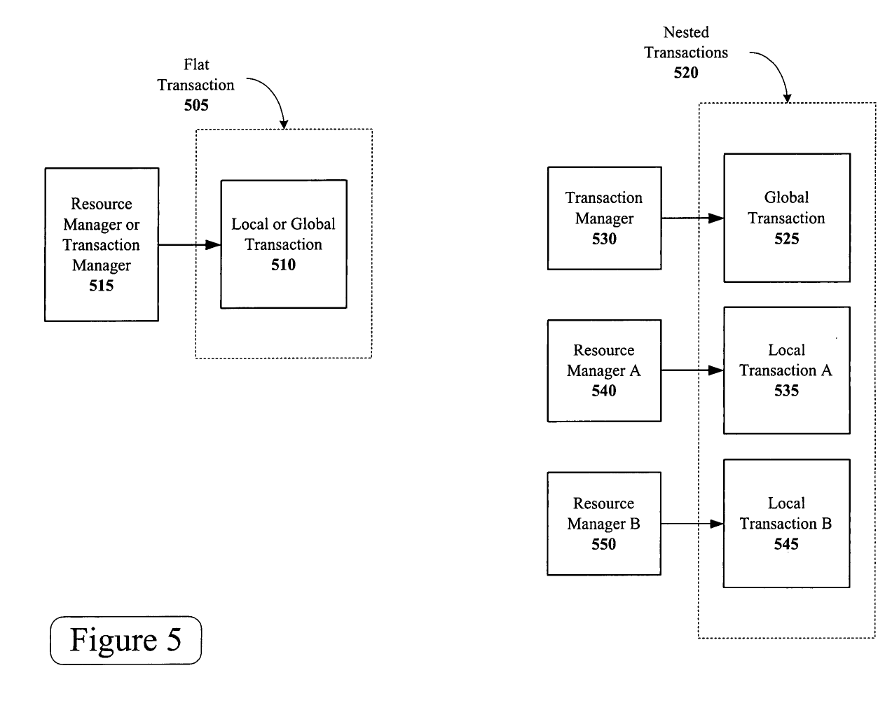

FIG. 5 is an illustration of nested transactions under an embodiment of the invention. In this illustration, a flat transaction 505 includes either a local transaction or a global transaction 510. The transaction 510 is then controlled locally or globally by an associated resource manager or transaction manager 515, as appropriate.

FIG. 5 also illustrates a nested transaction 520. The nested transaction 520 in this illustration is comprised of multiple transactions, specifically a global transaction 525, controlled by a transaction manager 530, and two local transactions, local transaction A 535 controlled locally by resource manager A 540 and local transaction B 545 controlled locally by resource manager B 550. In the case of the nested transactions, each transaction can be commenced and ended, by committing or rolling back, separately from the other transactions.

However, in general, an Enterprise JavaBean container supports flat transactions, but does not support nested transactions. For example, the EJB specification indicates that the architecture supports flat transactions, with enhancement required for nested transactions. In such environment, either a local transaction or a global transaction (which may comprise multiple co-managed transactions) is in place, but, if a global transaction is in place, a resource adapter will be required to be associated with the global transaction for operations during the pendency of the global transaction.

The XAResource (javax.transaction.xa.XAResource) interface is a Java mapping of the standard XA interface based on the X/Open CAE Specification (Distributed Transaction Processing: The XA Specification). The XAResource may define a contract between a resource manager and a transaction manager in a distributed transaction processing (DTP) environment. A resource adapter for a resource manager implements the XAResource to support association of a global transaction to a transaction resource. In this context, a global transaction is a unit of work performed by one or more resource managers in a distributed transaction processing system. The system relies on an external transaction manager, such as a transaction manager under the Java Transaction Service, to coordinate transactions.

Pursuant to the JTA, global transactions are associated with a transactional resource via the XAResource.start method and disassociated via the Xaresource.end method. XAResource does not support nested transactions, there being an error for the XAResource to be invoked on a connection that is currently associated with a different transaction. Under the JTA, if a resource adapter supports both local and global transactions and the same connection is used to perform both local and global transactions, any local transaction generally is required to committed or rolled back before starting a global transaction in the connection, and the global transaction is disassociated from the connection before a local transaction is started.

However, the operations of a resource adapter may not actually affect the operations of a global transaction. In such a situation, the operation of a nested transaction, involving a global transaction and one or more unrelated local transactions, may be practical. Under an embodiment of the invention, a resource adapter is not required to become part of a global transaction, if a global transaction exists. Under an embodiment of the invention, it is possible to manage a local transaction over a given connection independently from the global transaction that is place. The environment that is given the adapter by the server is used and the adapter manages the transaction separately from other transactions. Therefore, it is thus possible to start nested transactions that are comprised of one global transaction and one or more local transactions.

Under an embodiment of the invention, a reference object can be imported into a system using JNDI. The reference object carries specified information, which is used by a resource object factory and is used at lookup time for tuning up the underlying resource system. In general, a resource reference is an element in a deployment descriptor that identifies the component's coded name for the resource. Under an embodiment of the invention, it is possible to use a given adapter in a nested transaction by configuring and binding the resource reference or by looking up a currently bound non-transactional resource reference. Under an embodiment of the invention, taking such action will provide for a connection factory configured in the manner needed, a connection factory being an object that produces connection objects that enable a J2EE component to access a resource.

The JNDI contains four packages, one of which is the naming package javax.naming, containing classes and interfaces for accessing naming services. The reference class is object that exists outside of a directory. In general a reference may be used to provide JNDI clients that illusion that objects of arbitrary classes may be bound in naming or directory services that do not have native support for objects in the Java programming language. Under an embodiment of the invention, a reference is used for a non-transactional resource, the reference containing the properties for resource object factory allowing nested transactions. Specifically, an embodiment of the invention includes a reference for a non-transactional resource that will allow for the association of a resource adapter with a local transaction because there will be no requirement for associating with an existing global transaction.

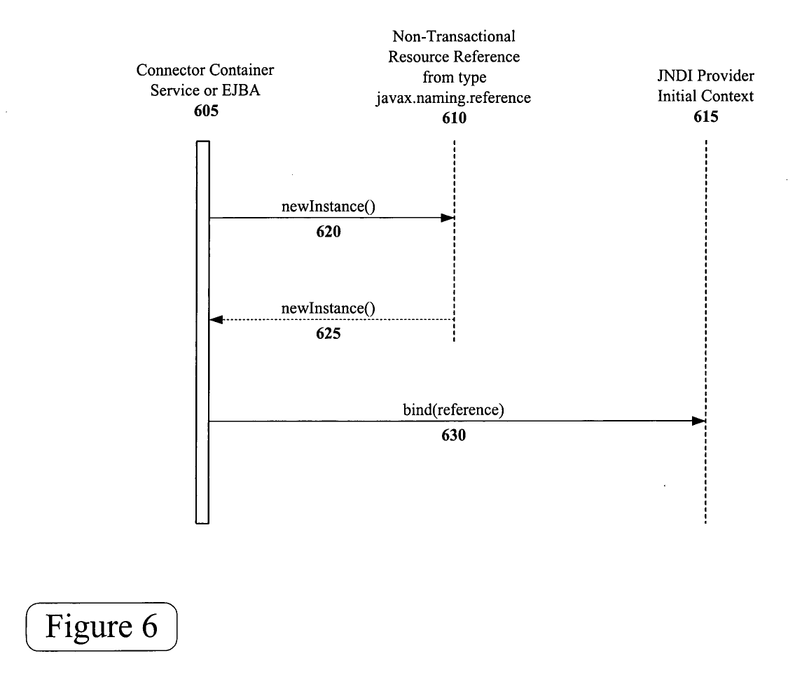

FIG. 6 is a diagram illustrating operations for establishment of a non-transactional resource reference under an embodiment of the invention. In this illustration, a connector container service or Enterprise JavaBean (denoted as EJB A) 605 makes a request for a new instance 620 of a non-transactional resource reference from type javax.naming.reference 610. Following the return for the instance request 625 the connector container service or EJB A 605 then binds the reference with the JNDI provider initial context 630.

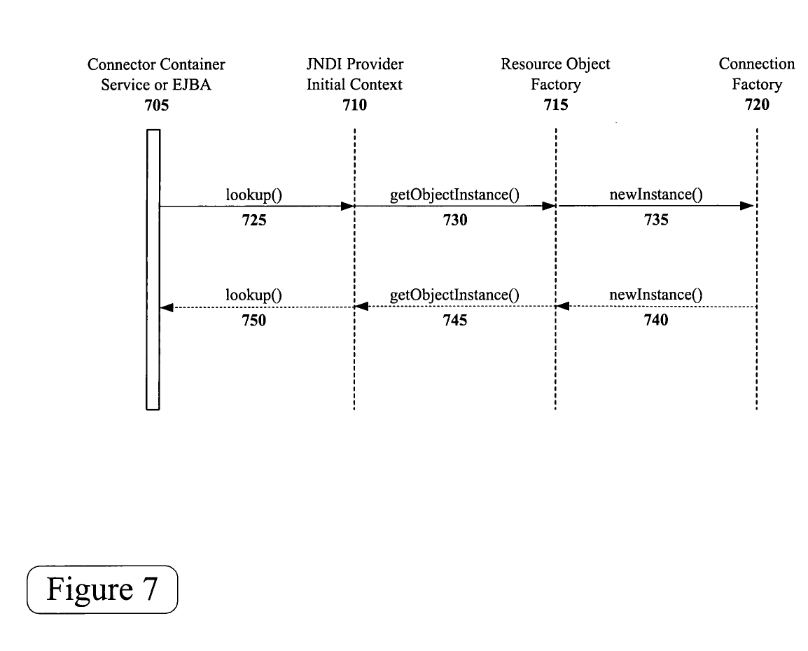

After binding, the non-transactional resource reference can then be obtained and implemented. FIG. 7 is a diagram illustrating operation for obtaining a non-transactional resource reference under an embodiment of the invention. In this illustration, an Enterprise JavaBean, denoted as EJB A 705, calls a method to obtain a connection factory for the needed resource reference. The EJB A 705 requests a lookup of the resource reference from the JNDI provider's initial context 710. The properties of the reference object will determine which object factory may be utilized to restore the object. A request to get an instance of the reference object is made to a resource object factory. All necessary properties from the reference object are used to create a factory with the requested behavior. The resource object factory then makes a request for a new instance 735 of the relevant connection factory 720. This is followed by the returns of the requests for a new instance of the connection factory 740, for getting an object instance 745, and for the lookup of the reference object. Under an embodiment of the invention, the local transaction based on the reference object may be obtained even if a global transaction is in place.

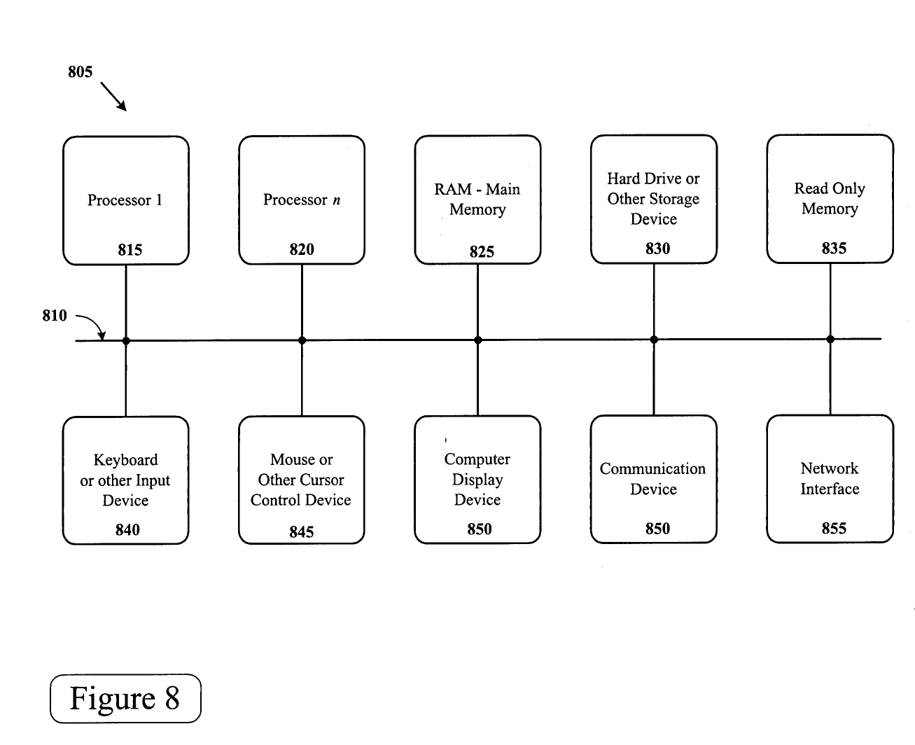

FIG. 8 illustrates an exemplary computer system environment under an embodiment of the invention. In this illustration, a computer 805 comprises a bus 810 or other means for communicating data. The computer 805 includes one or more processors, illustrated as shown as processor 1 815 through processor n 820 to process information.

The computer 805 further comprises a random access memory (RAM) or other dynamic storage as a main memory 825 to store information and instructions to be executed by the processor 815 through 820. The RAM or other main memory 825 also may be used for storing temporary variables or other intermediate information during execution of instructions by the processors 815 through 820.

A hard drive or other storage device 830 may be used by the computer 805 for storing information and instructions. The storage device 830 may include a magnetic disk or optical disc and its corresponding drive, flash memory or other nonvolatile memory, or other memory device. Such elements may be combined together or may be separate components. The computer 805 may include a read only memory (ROM) 835 or other static storage device for storing static information and instructions for the processors 815 through 820.

A keyboard or other input device 840 may be coupled to the bus 810 for communicating information or command selections to the processors 815 through 820. The input device 840 may include a keyboard, a keypad, a touch-screen and stylus, a voice-activated system, or other input device, or combinations of such devices. The computer may further include a mouse or other cursor control device 845, which may be a mouse, a trackball, or cursor direction keys to communicate direction information and command selections to the processors and to control cursor movement on a display device. The computer 805 may include a computer display device 850, such as a cathode ray tube (CRT), liquid crystal display (LCD), or other display technology, to display information to a user. In some environments, the display device may be a touch-screen that is also utilized as at least a part of an input device. In some environments, the computer display device 850 may be or may include an auditory device, such as a speaker for providing auditory information.

A communication device 850 may also be coupled to the bus 810. The communication device 850 may include a modem, a transceiver, a wireless modem, or other interface device. The computer 805 may be linked to a network or to other device using via an interface 855, which may include links to the Internet, a local area network, or another environment. The computer 805 may comprise a server that connects to multiple devices. In one embodiment the computer 805 comprises a Java compatible server that is connected to user devices and to external resources.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

1. A method comprising:
establishing a program object, the program object containing information regarding creation of a connection between a computer application and a resource; and
establishing a local transaction and associating the computer application with the local transaction, a global transaction being active at the time of association;
the local transaction being uninvolved with the global transaction.

2. The method of claim 1, wherein the local transaction operates in parallel at least in part with a global transaction.

3. The method of claim 2, wherein the local transaction and the global transaction comprise a nested transaction.

4. The method of claim 1, wherein the local transaction is managed by a resource manager for the connection.

5. The method of claim 1, wherein the global transaction is managed by a global agent.

6. The method of claim 5, wherein global agent comprises a transaction manager.

7. The method of claim 1, further comprising committing or rolling back the local transaction separately from committing or rolling back the global transaction.

8. The method of claim 1, wherein the program object comprises a Java reference type object.

9. The method of claim 8, wherein the reference to the program object is of type javax.naming.reference.

10. The method of claim 1, wherein the computer application comprises an Enterprise JavaBean (EJB).

11. The method of claim 1, further comprising providing the information contained in the program object upon request.

12. The method of claim 1, wherein establishing the program object comprises binding the program object utilizing a Java naming and directory interface (JNDI).

13. The method of claim 1, wherein the resource comprises an enterprise information system (EIS).

14. A server system comprising:
an application server, the application server including an application; and
an interface to an external resource, the server system to establish a connection between the application and the external resource;
the connection to be associated with a local transaction, the local transaction to be concurrent at least in part with a global transaction.

15. The server system of claim 14, wherein the local transaction is not associated with the global transaction.

16. The server system of claim 14, wherein the local transaction may be committed or rolled separately from the global transaction.

17. The server system of claim 14, further comprising a transaction manager, the transaction manager to manage the global transaction;

18. The server system of claim 17, wherein the local transaction is not controlled by the transaction manager.

19. The server system of claim 14, further comprising a resource manager for the interface.

20. The server system of claim 19, wherein the resource manager is to manage the local transaction.

21. The server system of claim 14, wherein the local transaction and the global transaction comprise a nested transaction.

22. The server system of claim 14, wherein the server system is to utilize a Java reference type object in establishment of the local transaction.

23. The server system of claim 14, wherein the application comprises an Enterprise JavaBean (EJB).

24. The method of claim 14, wherein the external resource is an enterprise information system (EIS).

25. A server system comprising:
means for establishing a connection between an application and an external resource;
means for establishing a local transaction; and
means for associating the application with the local transaction, a global transaction being active at the time of association, the local transaction and global transaction operating concurrently at least in part.

26. The server system of claim 25, wherein the local transaction is not associated with the global transaction.

27. The server system of claim 25, wherein the local transaction may be ended separately from the global transaction.

28. The server system of claim 27, wherein ending the local transaction comprises committing the transaction or rolling back the transaction.

29. The server system of claim 25, further comprising means for managing global transactions.

30. The server system of claim 29, wherein the local transaction is not managed by the means for managing global transactions.

31. The server system of claim 25, wherein the local transaction and the global transaction comprise a nested transaction.

32. The server system of claim 25, wherein means for establishing a local transaction utilizes a Java reference type object.

33. The server system of claim 25, wherein the computer application comprises an Enterprise JavaBean (EJB).

34. The server system of claim 25, wherein the external resource comprises an enterprise information system (EIS).

35. A machine-readable medium having stored thereon data representing sequences of instructions that, when executed by a processor, cause the processor to perform operations comprising:
establishing a program object, the program object containing information regarding creation of a connection between a computer application and a resource; and
establishing a local transaction and associating the computer application with the local transaction, a global transaction being active at the time of association;
the local transaction being uninvolved with the global transaction.

36. The medium of claim 35, wherein the local transaction operates in parallel at least in part with a global transaction.

37. The medium of claim 36, wherein the local transaction and the global transaction comprise a nested transaction.

38. The medium of claim 35, wherein the local transaction is managed by a resource manager for the connection.

39. The medium of claim 35, wherein the global transaction is managed by a global agent.

40. The medium of claim 35, wherein global agent comprises a transaction manager.

41. The medium of claim 35, further comprising instructions that, when executed by the processor, cause the processor to perform operations comprising committing or rolling back the local transaction separately from committing or rolling back the global transaction.

42. The medium of claim 35, wherein the program object comprises a Java reference type object.

43. The medium of claim 42, wherein the reference to the program object is of type javax.naming.reference.

44. The medium of claim 35, wherein the computer application comprises an Enterprise JavaBean (EJB).

45. The medium of claim 35, further comprising instructions that, when executed by the processor, cause the processor to perform operations comprising providing the information contained in the program object upon request.

46. The medium of claim 35, wherein establishing the program object comprises binding the program object utilizing a Java naming and directory interface (JNDI).

47. The medium of claim 35, wherein the resource comprises an enterprise information system (EIS).
